(19) United States
(12) Patent Application Publication
(10) Pub. No.: US 2015/0100382 A1
(43) Pub. Date: Apr. 9, 2015

(54) SYSTEM FOR POLICY MANAGEMENT AND ANALYTICS

(71) Applicants: Baljeet Singh MALHOTRA, Singapore (SG); Abraham Sasmito ADIBOWO, Singapore (SG); Andreas Kurt PURSCHE, Singapore (SG); Satya Ashok SREENIVASAN, Singapore (SG); Subashini RENGARAJAN, Singapore (SG); Jun Wei LOW, Singapore (SG)

(72) Inventors: Baljeet Singh MALHOTRA, Singapore (SG); Abraham Sasmito ADIBOWO, Singapore (SG); Andreas Kurt PURSCHE, Singapore (SG); Satya Ashok SREENIVASAN, Singapore (SG); Subashini RENGARAJAN, Singapore (SG); Jun Wei LOW, Singapore (SG)

(21) Appl. No.: 14/045,810

(22) Filed: Oct. 4, 2013

(51) Int. Cl. G06Q 30/02

(52) U.S. Cl. CPC G06Q 30/0203
USPC 705/7.32

(57) ABSTRACT

Described herein is a technology for facilitating policy management. In accordance with one aspect, the technology includes, but is not limited to, gathering of personal data related to users, and determining policy topics that are relevant to the specific users based on their personal profile and other criteria as defined by the users. Policy updates, including new policies or changes to the existing ones, which are most relevant to the users may further be provided in a systematic way.

### TECHNICAL FIELD

The present disclosure relates generally to management of policies applicable to users.

### BACKGROUND

Policies are events, rules, standards, etc. that are implemented by entities such as governments, corporations, non-profit businesses, and the like that affect individuals and groups. For example, a government may implement policies that affect its citizens, businesses, visitors, etc.

New policies are continually created and implemented. Existing policies are updated. The affected individuals and groups, or users are often unaware of such new policies and any updates to policies that affect them. Typically, new policies or policy changes are reported on various media. A user must proactively search for such new policies and policy changes. Users not only have to search for such policies, but determine if it is relevant to them and how it affects them, sometimes in a time dependent manner.

### BRIEF DESCRIPTION OF THE DRAWINGS

FIG. 1 illustrates an exemplary process in accordance with the technology described herein;

FIGS. 2-8 show exemplary user interface views that may be produced by one or more implementations in accordance with the technology described herein;

FIG. 9 illustrates an exemplary system architecture in accordance with the technology described herein;

FIG. 10 illustrates an exemplary process in accordance with the technology described herein;

FIG. 11 illustrates an exemplary process in accordance with the technology described herein; and

FIG. 12 illustrates an exemplary computing system to implement in accordance with the technologies described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Disclosed herein are technologies for providing new policies and policy updates to individuals and groups, collectively referred to as users. Examples of policy implementing entities may be governments and governmental units, large companies, non-profit organizations, etc. Policy implementing entities typically formulate and implement policies and put them out for the general populace.

Using conventional approaches, users often are unable to precisely and accurately search and locate applicable policies from different policy implementing entities (e.g., government agencies). In addition, it is desirable for entities administering policies to receive feedback from the users. Feedback allows the entities to gauge users' interest in the policy, provide better policy implementation, and determine effectiveness of the policies. Oftentimes, gathering feedback labor and resource extensive outreach and polling programs are employed to gather user feedback.

In accordance with the technology described herein, a user through an interface (such as a mobile application on a phone), is able to receive relevant policies, policy updates, policy information, and other information that is relevant to the user. Such policy data is provided in a timely and efficient manner, allowing users to determine how such policy(ies) personally affect them. In addition, policy implementing entities may receive feedback, allowing them to better formulate and administer policies.

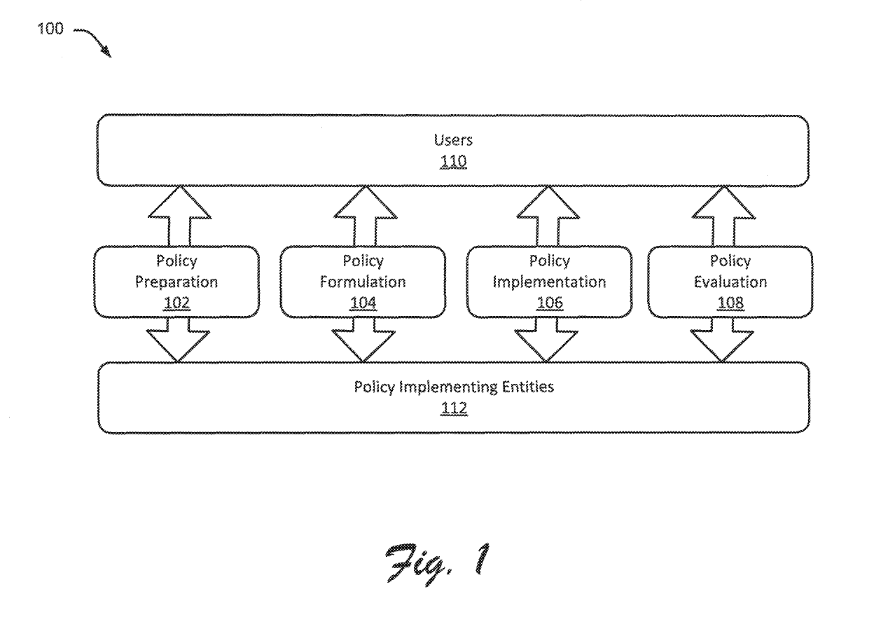

FIG. 1 depicts an exemplary policy process 100. Traditionally, the acts of policy preparation 102, policy formulation 104, policy implementation 106, and policy evaluation 108 follows one another in order. In the policy process 100, acts or mechanisms (i.e., policy preparation 102, policy formulation 104, policy implementation 106, and policy evaluation 108) may be executed in parallel. Users 110 and policy implementing entities 112 directly communicate and share the acts and mechanisms. In this manner, both users 110 and policy implementing entities 112 may effectively receive information and feedback from one another.

Process 100 provides the flexibility of delivery of policies (i.e., time) since one mechanism need not follow another. In addition process 100 provides the flexibility of where (i.e., region, areas, etc.) to deliver such policies and to who (i.e., specific users/groups of users, etc.) to deliver.

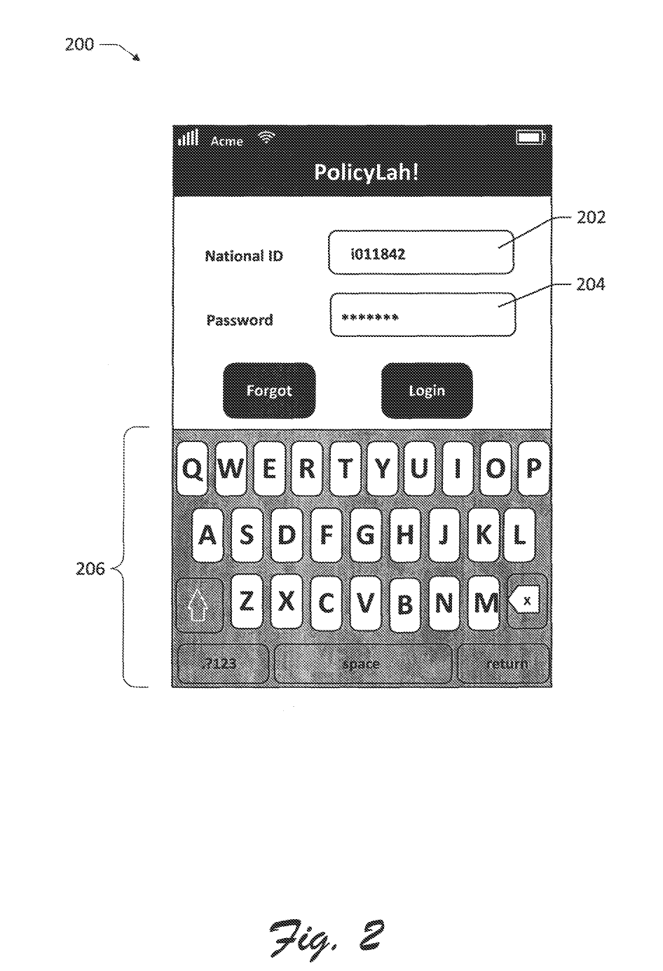

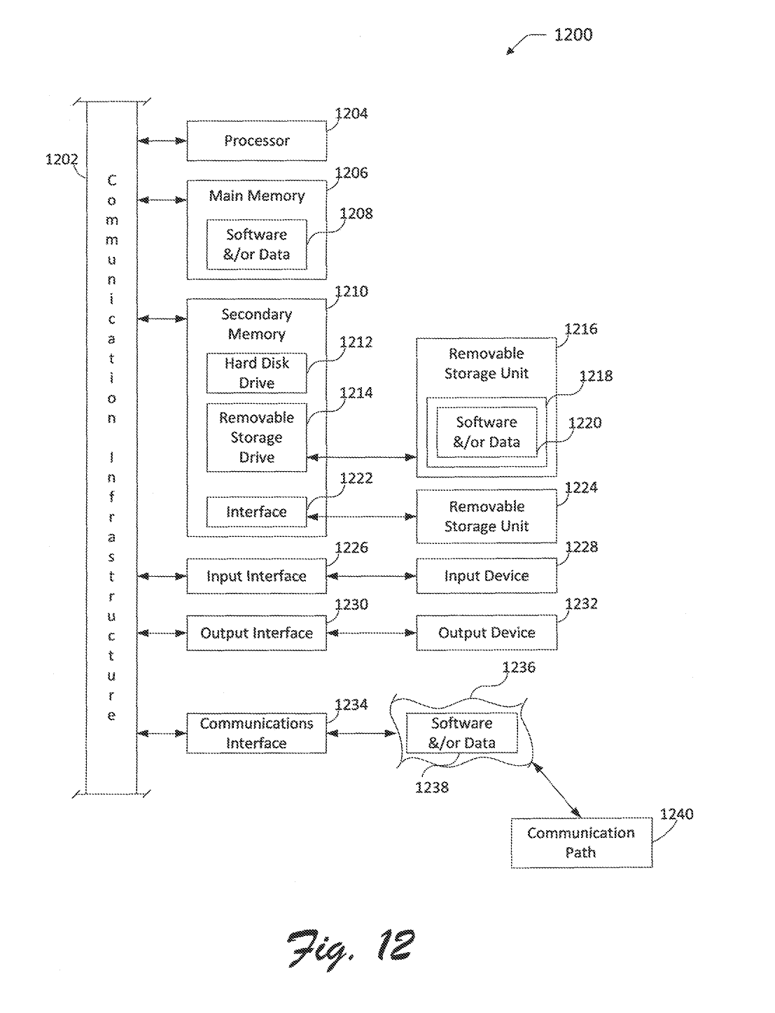

FIGS. 2-8 show exemplary of user interface (UI) views that may be presented to a user, allowing the user to receive policy, policy updates and related information. In addition, the UI views allow for feedback to policy implementing entities. Such UI views may be implemented using various computing platforms, such as a mobile device, personal computer, tablet, etc. An exemplary architecture of such a computing platform is described below with reference to FIG. 12.

FIG. 2 shows an example UI view 200 allowing a user to logon to the policy system. In this example, the user provides an identifier or ID 202 along with a password 204. Also in this example, a virtual keyboard 206 is provided in UI view 200.

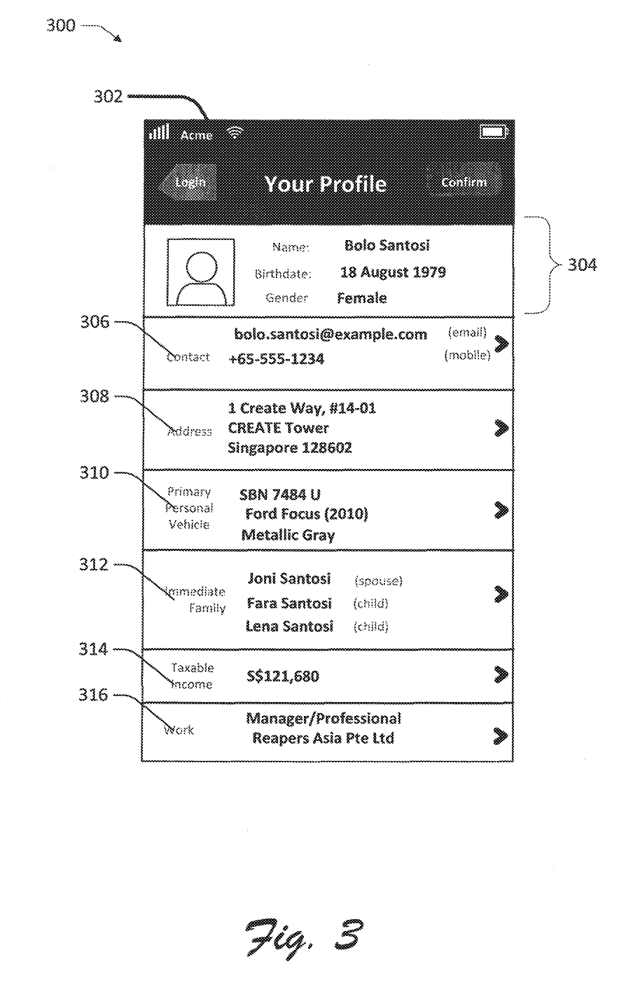

FIG. 3 shows an example UI view 300 that provides the user specific information about themselves. After the user logs in, UI view 300 is presented. Through UI view 300, the user is able to see if the personal information is correct, and update or modify the information. UI view 300 particularly provides a profile 302 of the user.

In this example, the user is identified by name, birthdate and gender 304. In addition, other example data may be provided, such as contact 306, address 308, primary vehicle 310, immediate family 312, taxable income 314 and work/job 316. Such data may be used to search and determine the applicable policy to the user.

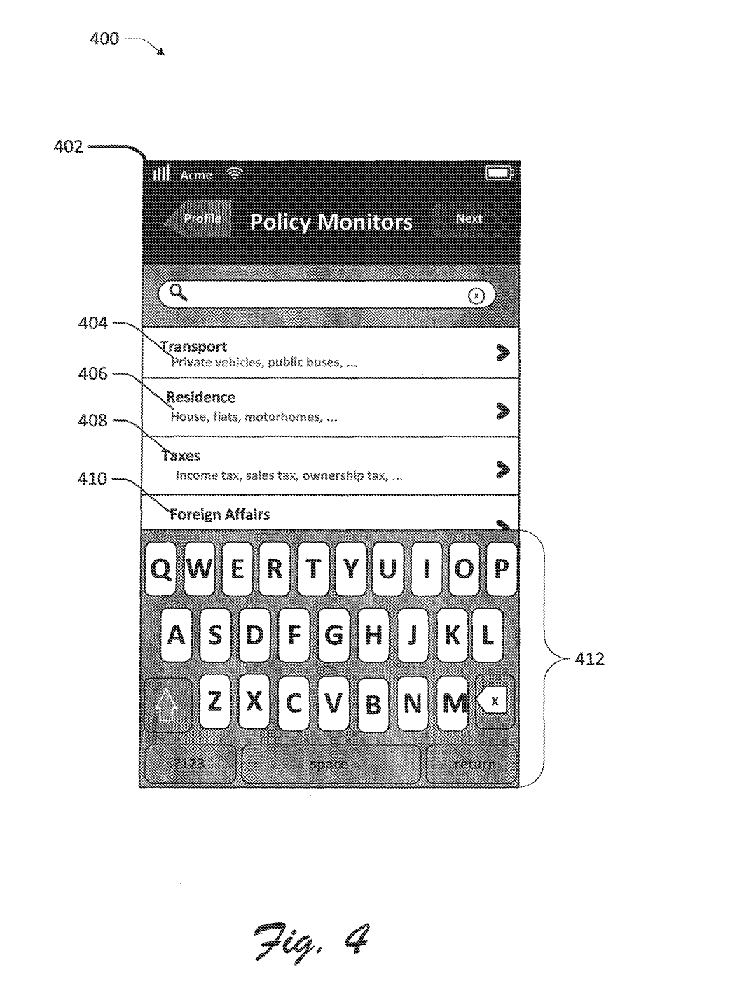

FIG. 4 shows an example UI view 400 that provides policy monitors 402 to the user. Policy monitors track particular policies that may be relevant to a user. In this example, the policy monitors 402 are directed to transport 404, residence 406, taxes 408, and foreign affairs 410. The policy monitors 402 may be based on the profile of the user as depicted in UI view 300. In certain implementations, a policy implementing entity(ies), such as a government may determine such policy monitors. In certain implementations, the user may determine which policy monitors are provided. In this example, a virtual keyboard 412 is provided to the user.

In certain implementations, the policy monitors may be presented in rank order. In other words, the most important or relevant policy monitors may be presented at the top of the list. It is to be understood, that other ordering may also be implemented.

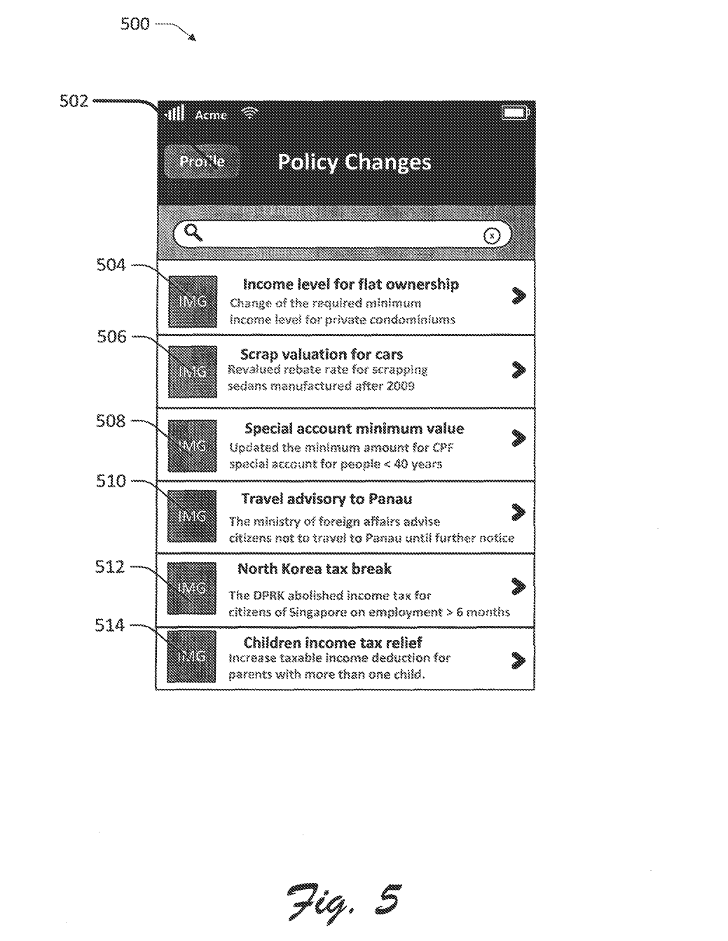

FIG. 5 shows an example UI view 500 that provides policy changes 502 to the user. Based on the policy monitors of UI view 400 and/or other metrics, policy changes 502 are provided to the user. Policy changes 502 may include new policies and/or updates to existing policies. The policy changes are determined to have some relevancy to the user. In this example, the policy changes 502 include income level for flat ownership 504, scrap valuation for cars 506, special account minimum value 508, travel advisory to Panau 510, North Korea tax break 512 and children income tax relief 514. In certain cases, the policy changes are not only specific to the user, but may include applicable information to the general populace, such as the travel advisory to Panau 510.

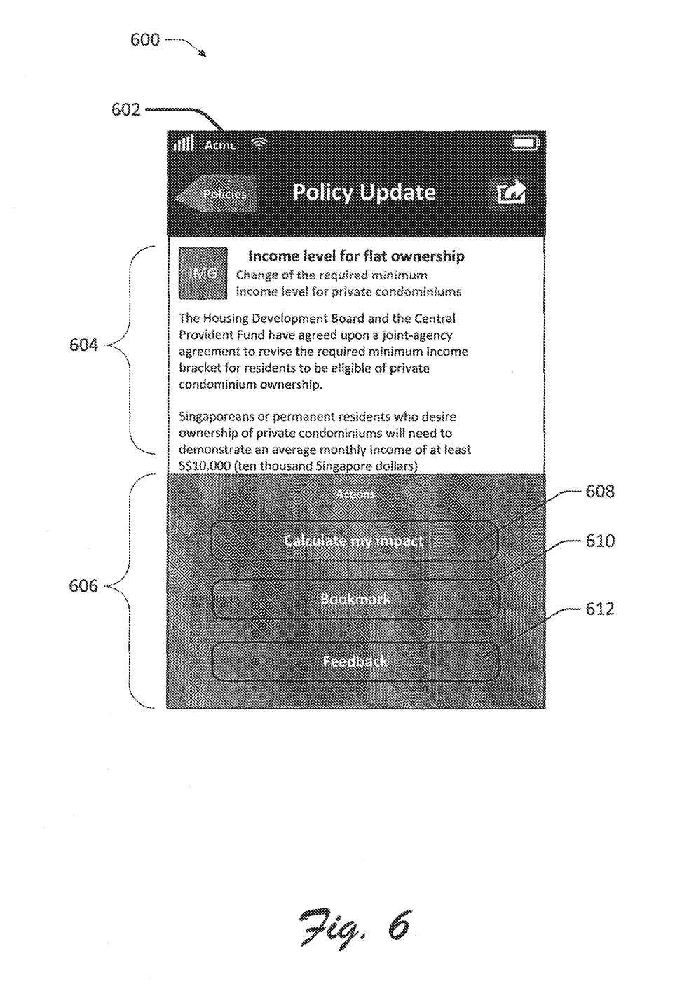

FIG. 6 shows an example UI view 600 of a particular policy update 602. In this example, the user selects from the menu of policy changes presented in UI view 500. In this case, the user selected income level for flat ownership 504. A description 604, either general or specific, is provided to the user describing a change in income level for flat ownership.

The user may take additional action after reviewing the policy update, as provided by actions 606. In this example, actions 606 that are available to the user are calculate my impact 608, bookmark 610, and feedback 612. Calculate my impact 608 may include information as to how the user is affected by the policy change, using the personal information of the user that is known. In addition, links to resources may be provided to the user to assist the user as to the policy update. For example, links to banks and/or mortgage calculator programs may be provided.

In certain cases, the policy implementing entity (e.g., government) may determine the interest and impact of its policy(ies) by the interaction of the user with the action 608. This is an indirect feedback from the user(s). However, in this example, the user is also able to provide direct and specific feedback through a feedback action 612.

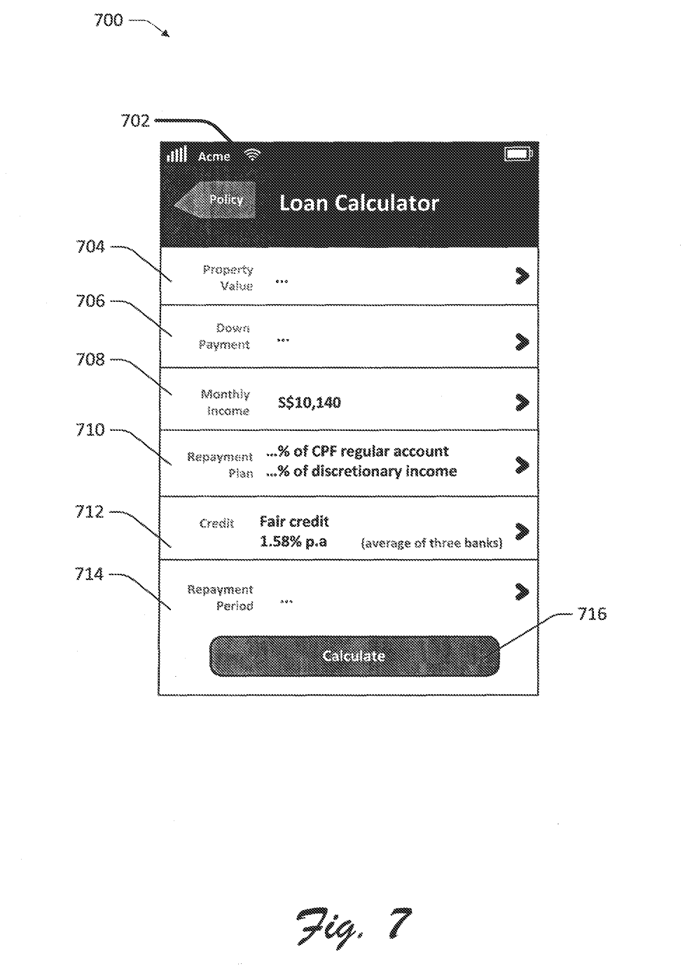

FIG. 7 shows an example UI view 700 of loan calculator 702. The loan calculator is an example of a resource that may be presented to the user based on the user selecting the “calculate my impact” 608 button presented in UI view 600, and particularly actions 606.

The Loan calculator 702 uses several fields to calculate particular values. In this example, the fields include property value 704, down payment 706, monthly income 708, repayment plan 710, credit score 712, and repayment period 714. Since there is certain information that the loan calculator 702 knows of the user, such as the user's income, particular fields may be prefilled. Other fields may require the user to provide input. A calculate key 716 is provided to run the loan calculator 702.

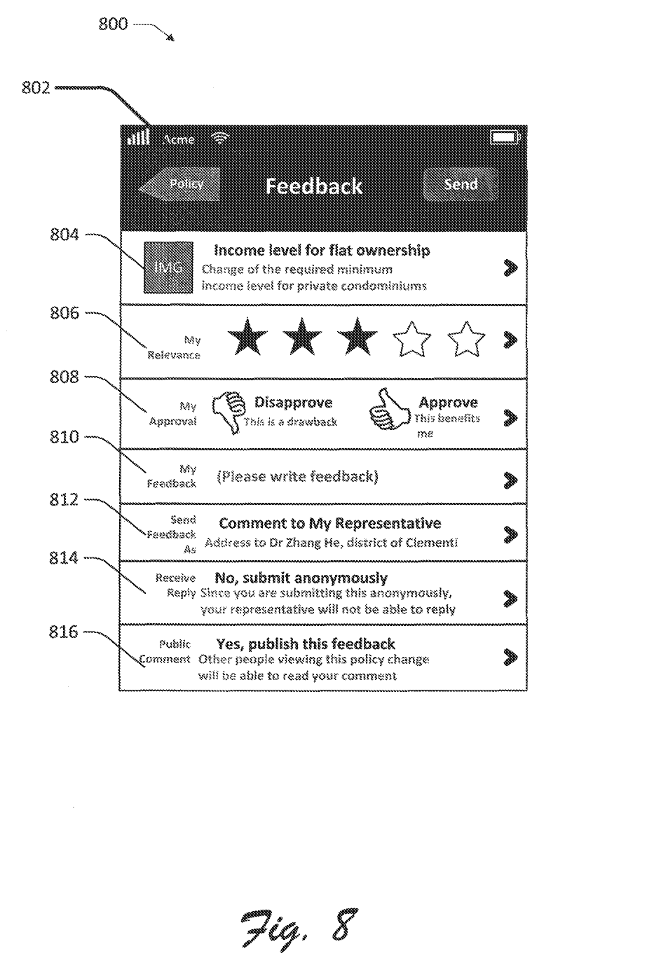

FIG. 8 shows an exemplary UI view 800 for feedback 802 to the policy implementing entity. As discussed above UI 600 provides action 608 that may be selected by a user, and other actions such as feedback 612. In this example, the feedback 802 is directed to the particular policy income level for flat ownership 804. The user may provide input to various fields in the feedback 802. In this example, the fields include my relevance 806, my approval 808, my feedback 810, send feedback as 812, receive reply 814, and public comment 816. Such feedback allows the policy implementing entity to better administrate the policy(ies) and determine their use and interest with the users.

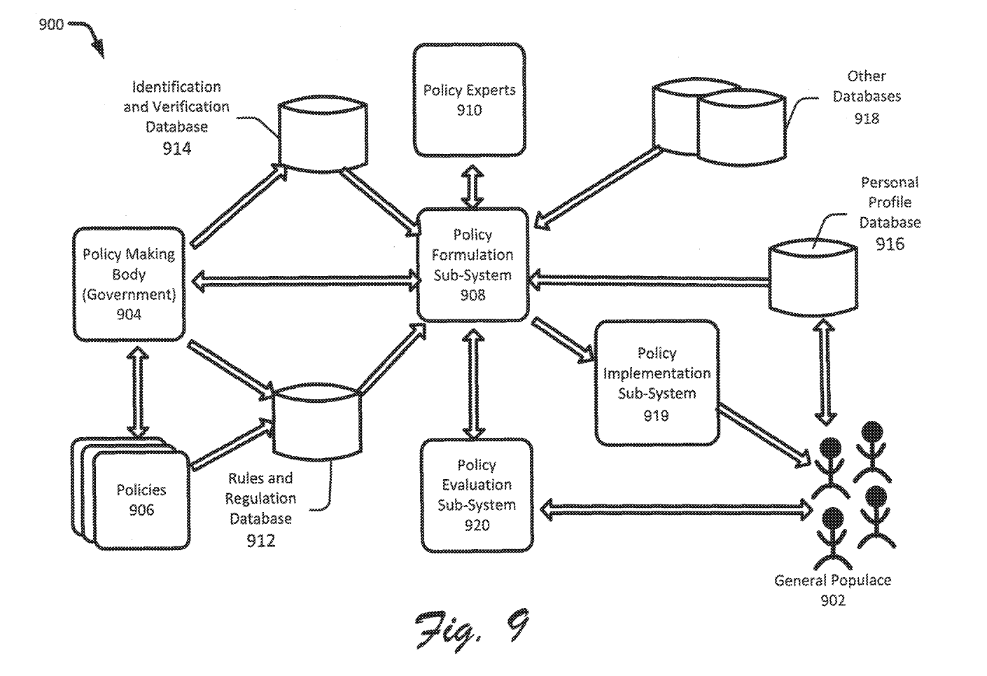

FIG. 9 illustrates an exemplary system architecture 900 for implementing, at least in part, the technology described herein. In particular, system architecture 900 depicts an implementation for providing policy updates, management, and feedback between policy administrative entities and users.

A general populace 902 of users has particular policies that affect individual users. A policy making body 904, such as a government, may be considered as a policy implementing entity as discussed above. In certain cases, the policy making body 904 is the sole entity that creates policies 906; however, in the exemplary system, a policy formulation sub-system 908 also receives input and provides output from policy experts 910.

The policy formulation sub-system 908 receives policies 906 from a rules and regulation database 912, data from an identification and verification database 914, a personal profile database 916, and other relevant databases 918. Policy implementation sub-system 919 provides the policies to the general populace 902, and policy evaluation sub-system 920 evaluates implementation of the policies.

As shown in FIG. 9, the various elements are connected with one another showing either one way arrows or two way arrows, that represent input and output, or input from one element to another/output from one element to another.

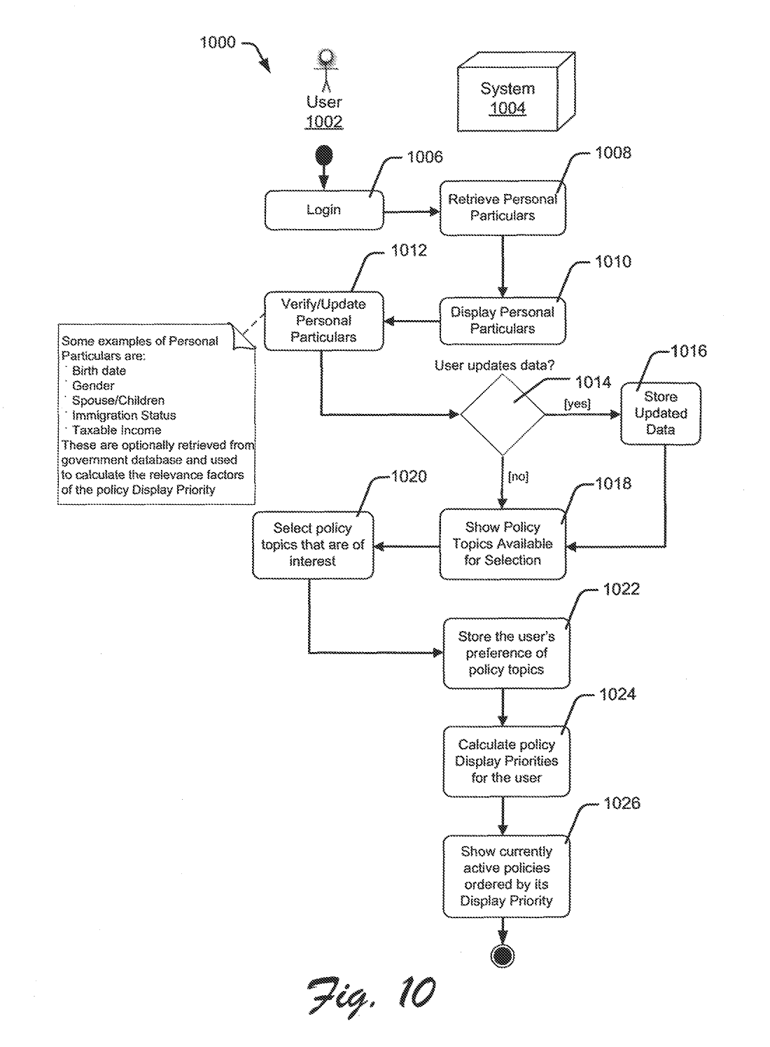

FIG. 10 illustrates an exemplary process 1000 for implementing, at least in part, the technology described herein. In particular, process 1000 depicts an onboarding flow that provides new and updated policies to users, and provides feedback to policy implementing entities. The process 1000 may be performed by a computing device or devices. An example architecture of such a computer device is described below with reference to FIG. 12.

In this particular example, the process 1000 describes that certain acts are be performed at or by a user 1002 or a system 1004.

At 1006, a user logs in. In certain implementations, this is a login as described above.

At 1008, personal particulars related to the user 1002 are retrieved.

At 1010, the retrieved personal particulars are displayed.

At 1012, the retrieved personal particulars are verified and/or updated.

At 1014, a determination is made if the user has updated his or her data. If the data is updated, following the “yes” branch of 1014, at 1016, the updated data is stored. Otherwise, if the user did not update data, following the “no” branch of 1014, at 1018, policy topics that are available for selection are shown.

At 1020, the policies of interest are selected.

At 1022, the user's preferences of policy topics are stored.

At 1024, policy priorities are calculated for the user.

At 1026, currently active policies are displayed by their order of priority.

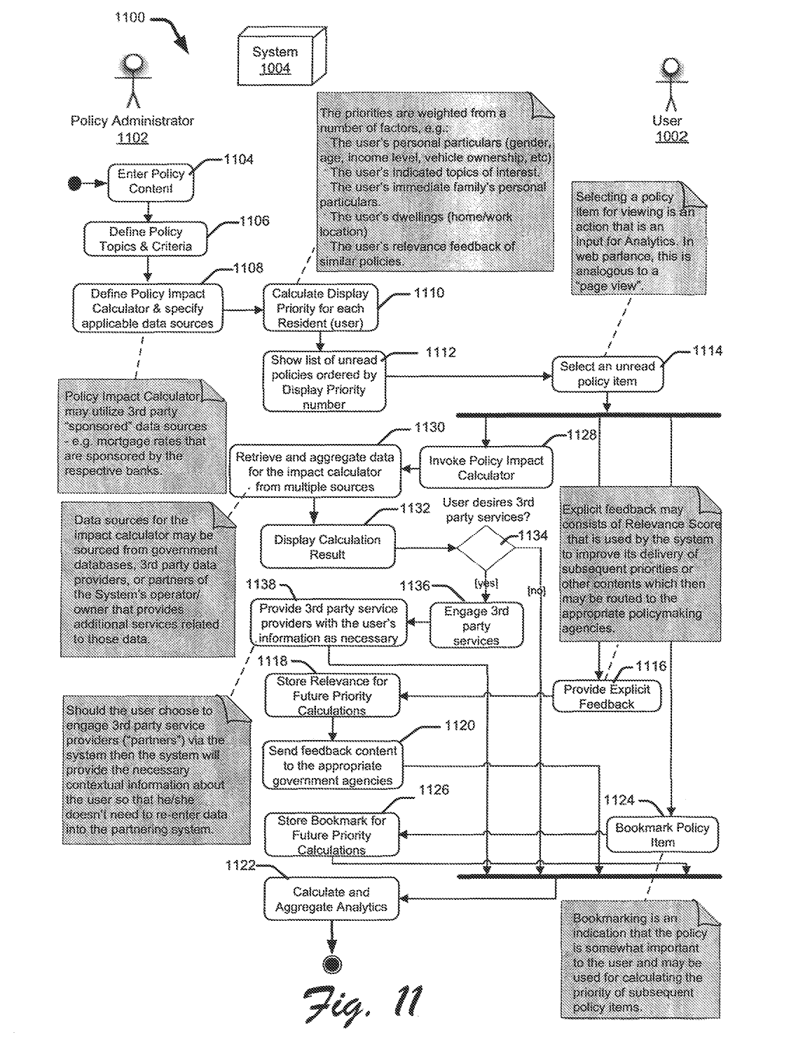

FIG. 11 illustrates an exemplary process 1100 for implementing, at least in part, the technology described herein. In particular, process 1100 depicts distributing new and updated policies to users, and providing feedback to policy implementing entities. The process 1100 may be performed by a computing device or devices. An example architecture of such a computer device is described below in FIG. 12.

In this particular exemplary process 1100, certain acts are described to be performed at or by a user 1002 or a system 1004, or policy administrator 1102.

At 1104, policy content is entered.

At 1106, policy topics and criteria are defined.

At 1108, a policy impact calculator may be defined and applicable data sources are identified.

At 1110, priority for each user/resident is calculated.

At 1112, a list of policies that are not read by the user is displayed by priority.

At 1114, an unread policy item is selected.

At 1116, explicit feedback is provided.

At 1118, feedback is stored based on relevance.

At 1120, feedback content is sent to appropriate policy entities, such as government agencies.

At 1122, analytics are calculated and aggregated.

At 1124, a policy item may be bookmarked, following 1114 and continuing on to 1126, where the bookmark is stored for future priority calculations. At 1122, analytics are calculated and aggregated.

At 1128, the policy impact calculator may be invoked following 1114.

At 1130, data for impact calculator from various sources is retrieved and aggregated.

At 1132, calculation results are displayed.

At 1134, a decision is made as to the use of third party services, such as lending institutions, etc. If no third party services are desired, following the “no” branch of 1134, at 1122, analytics are calculated and aggregated. If third party services are desired, following the “yes” branch of 1134, at 1136, third parties are engaged.

At block 1138, the third party services are provided with relevant user information.

FIG. 12 illustrates an exemplary system 1200 that may implement, at least in part, the technologies described herein. The computer system 1200 includes one or more processors, such as processor 1204. Processor 1204 can be a special-purpose processor or a general-purpose processor. Processor 1204 is connected to a communication infrastructure 1202 (for example, a bus or a network). Depending upon the context, the computer system 1200 may also be called a client device.

Computer system 1200 also includes a main memory 1206, preferably Random Access Memory (RAM), containing possibly inter alia computer software and/or data 1208.

Computer system 1200 may also include a secondary memory 1210. Secondary memory 1210 may include, for example, a hard disk drive 1212, a removable storage drive 1214, a memory stick, etc. A removable storage drive 1214 may comprise a floppy disk drive, a magnetic tape drive, an optical disk drive, a flash memory, or the like. A removable storage drive 1214 reads from and/or writes to a removable storage unit 1216 in a well-known manner. A removable storage unit 1216 may comprise a floppy disk, a magnetic tape, an optical disk, etc. which is read by and written to by removable storage drive 1214. As will be appreciated by persons skilled in the relevant art(s) removable storage unit 1216 includes a computer usable storage medium 1218 having stored therein possibly inter alia computer software and/or data 1220.

In alternative implementations, secondary memory 1210 may include other similar means for allowing computer programs or other instructions to be loaded into computer system 1200. Such means may include, for example, a removable storage unit 1224 and an interface 1222. Examples of such means may include a program cartridge and cartridge interface (such as that found in video game devices), a removable memory chip (such as an Erasable Programmable Read-Only Memory (EPROM), or Programmable Read-Only Memory (PROM)) and associated socket, and other removable storage units 1224 and interfaces 1222 which allow software and data to be transferred from the removable storage unit 1224 to computer system 1200.

Computer system 1200 may also include an input interface 1226 and a range of input devices 1228 such as, possibly inter alia, a keyboard, a mouse, etc.

Computer system 1200 may also include an output interface 1230 and a range of output devices 1232 such as, possibly inter alia, a display, one or more speakers, etc.

Computer system 1200 may also include a communications interface 1234. Communications interface 1234 allows software and/or data 1238 to be transferred between computer system 1200 and external devices. Communications interface 1234 may include a modem, a network interface (such as an Ethernet card), a communications port, a Personal Computer Memory Card International Association (PCMCIA) slot and card, or the like. Software and/or data 1238 transferred via communications interface 1234 are in the form of signals 1236 which may be electronic, electromagnetic, optical, or other signals capable of being received by communications interface 1234. These signals 1236 are provided to communications interface 1234 via a communications path 1240. Communications path 1240 carries signals and may be implemented using a wire or cable, fiber optics, a phone line, a cellular phone link, a Radio Frequency (RF) link or other communication channels.

As used in this document, the terms “computer-program medium,” “computer-usable medium,” and “computer-readable medium” generally refer to media such as removable storage unit 1216, removable storage unit 1224, and a hard disk installed in hard disk drive 1212. Computer program medium and computer usable medium can also refer to memories, such as main memory 1206 and secondary memory 1210, which can be memory semiconductors (e.g. Dynamic Random Access Memory (DRAM) elements, etc.). These computer program products are means for providing software to computer system 1200.

Computer programs (also called computer control logic) are stored in main memory 1206 and/or secondary memory 1210. Such computer programs, when executed, enable computer system 1200 to implement the present technology described herein. In particular, the computer programs, when executed, enable processor 1204 to implement the processes of aspects of the above. Accordingly, such computer programs represent controllers of the computer system 1200. Where the technology described herein is implemented, at least in part, using software, the software may be stored in a computer program product and loaded into computer system 1200 using removable storage drive 1214, interface 1222, hard disk drive 1212 or communications interface 1234.

The technology described herein may be implemented as computer program products comprising software stored on any computer useable medium. Such software, when executed in one or more data processing devices, causes data processing device(s) to operate as described herein. Embodiments of the technology described herein may employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory (CD-ROM) disks, Zip disks, tapes, magnetic storage devices, optical storage devices, Microelectromechanical Systems (MEMS), and nanotechnological storage device, etc.).

A computing system may take the form of any combination of one or more of inter alia a wired device, a wireless device, a mobile phone, a feature phone, a smartphone, a tablet computer (such as for example an iPad™), a mobile computer, a handheld computer, a desktop computer, a laptop computer, a server computer, an in-vehicle (e.g., audio, navigation, etc.) device, an in-appliance device, a Personal Digital Assistant (PDA), a game console, a Digital Video Recorder (DVR) or Personal Video Recorder (PVR), a cable system or other set-top-box, an entertainment system component such as a television set, etc.

In the above description of exemplary implementations, for purposes of explanation, specific numbers, materials configurations, and other details are set forth in order to better explain the present invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventors do not intend these exemplary implementations to limit the scope of the appended claims. Rather, the inventor has contemplated that the claimed invention might also be embodied and implemented in other ways, in conjunction with other present or future technologies.

Moreover, the word “exemplary” is used herein to mean serving as an example, instance, or illustration. Any aspect or design described herein as exemplary is not necessarily to be construed as preferred or advantageous over other aspects or designs. Rather, use of the word “exemplary” is intended to present concepts and techniques in a concrete fashion. The term “technology,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

One or more embodiments described herein may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

what is claimed is:

1. A method that facilitates policy management, the method comprising:
retrieving personal information of a user;
providing a list of policy topics relevant to the user based on the personal information;
determining specific policy topics from the list of policy topics, based on interest to the user;
monitoring status of policies based on the specific topics that are of interest to the user;
delivering specific policy updates or new policies to a chosen set of users;
collecting feedback from the users that have received the specific policy updates or new policies; and
providing collaborative mechanisms to policy formulators to create, consume, and share data analytics based on the feedback provided by the users to formulate new policies or update the existing ones.

2. The method according to claim 1, wherein the personal information of the user is updated by the user, and the user is able to change, add, or remove the personal information.

3. The method according to claim 1, wherein the providing the list of policy topics includes prioritizing the policy topics.

4. The method according to claim 1, wherein the determining the specific policy topics that are of interest includes selection by the user.

5. The method according to claim 1, wherein the monitoring includes determining changes to existing policies and new policies that affect the user.

6. The method according to claim 1, wherein the monitoring includes policy update directed to a specific policy of a list of policies presented to the user.

7. The method according to claim 1, wherein the monitoring includes providing for user-initiated actions directed to a selected policy update.

8. The method according to claim 7, wherein the actions is selected from a group consisting of calculating impact, bookmark, and feedback.

9. The method according to claim 1 further comprising providing a set of tools such as calculators to assess the impact of a policy.

10. The method according to claim 1 further comprising providing a user selected information of a corresponding user.

11. The method according to claim 1 further comprising providing a set of services based on policy and customer data as well as data and visual analytics to third parties.

12. The method according to claim 1 further comprising providing user feedback to a policy implementing entity based on the user's view of the policy topics.

13. One or more computer-readable media storing processor-executable instructions that when executed cause one or more processors to perform operations that facilitates policy management, the operations comprising:
logging in a user;
gathering personal data related to the user;
determining policy topics that are relevant to the user based on the personal data; and
providing policy changes as to new and updated policies based on the policies that are relevant to the user.

14. The one or more computer-readable media according to claim 13, wherein the determining policy topics includes rank ordering the policy topics.

15. The one or more computer-readable media according to claim 13 further comprising:
selecting from the determined policy topics the most relevant policy topics to the user.

16. The one or more computer-readable media according to claim 13, wherein the providing policy changes as to new and updated policies based on the policies that are relevant to the user includes a specific policy update to a particular policy.

17. The one or more computer-readable media according to claim 16 further comprising:
selecting from one or more actions including but not limited to calculating impact, bookmarking, and providing feedback through various mechanisms such as text, speech etc. related to the particular policy.

18. The one or more computer-readable media according to claim 13 further comprising:
providing direct and indirect feedback to a policy implementing entity as to a particular policy.

19. The one or more computer-readable media according to claim 13 further comprising:
determining whether third party services are applicable to particular policies.

20. A system that facilities policy management, the system comprising:
a policy formulation sub-system that manages various types of information received from policy formulating experts as well as other systems that are needed to formulate and/or update the policies;
a policy implementation sub-system that distributes or communicates the policies or the policy changes to users; and
a policy evaluation sub-system that receives data from the users and provides feedback to the policy formulation sub-system.

21. The system according to claim 20, wherein the feedback is provided to a policy making entity and policy experts.

22. The system according to claim 20, wherein the users provide individual user information to the policy formulation sub-system.
